(19) United States
(12) Patent Application Publication
(10) Pub. No.: US 2026/0366453 A1
(43) Pub. Date: Nov. 19, 2026

(54) FUEL MIXTURE SUPPLY SYSTEM AND METHOD FOR IMPLEMENTING SAME

(71) Applicant: VIANNEY RABHI, LYON (FR)

(72) Inventor: VIANNEY RABHI, LYON (FR)

(21) Appl. No.: 19/675,614

(22) Filed: May 13, 2026

Related U.S. Application Data
(60) Provisional application No. 63/804,785, filed on May 13, 2025.

(51) Int. Cl. F02B 1/04; F02B 19/12; F02B 19/18; F02M 23/00; F02M 23/04; F02M 61/14

(52) U.S. Cl. CPC F02B 1/04; F02B 19/12; F02B 19/18; F02M 23/04; F02M 61/14; F02M 2023/008

(57) ABSTRACT

The fuel mixture supply system (60) for supplying an ignition pre-chamber (1) with a fuel mixture AF by means of a lamination injector (6) with an air compressor (32), the compressed air outlet port (77) of which, is connected to a compressed air reservoir (61), an air-fuel mixer (72), a mixer compressed air inlet (74) of which, is connected to said reservoir (61), and a mixer outlet (69) connected to the lamination injector (6), a reservoir pressure sensor (78) measuring the pressure in the compressed air reservoir (61) while a mixer pressure sensor (79) measures the pressure at the mixer compressed air inlet (74), a controlled pressure regulator (80) being placed between the reservoir outlet port (81) and the mixer compressed air inlet (74).

The present invention relates to a fuel mixture supply system for an active ignition pre-chamber, and to the method for implementing same.

The maximum effective efficiency of reciprocating internal combustion engines used in automobiles is of the order of thirty-eight percent in the case of Otto cycle spark ignition engines, and about forty percent in the case of diesel cycle engines.

With regard to the average efficiency in current use of said engines, it is most often less than twenty-five percent for spark ignition engines, and thirty percent for diesel engines, which leads to significant greenhouse gas emissions and an accelerated depletion of fossil energy resources, mainly petroleum.

In addition to low efficiency, these engines produce polluting gases and fine particles harmful to the environment and health.

Despite these not very advantageous characteristics, due to the lack of alternative solutions offering a better energy, environmental, functional and economic compromise, Otto or Diesel cycle internal combustion engines equip the vast majority of motor vehicles in circulation around the world.

The supremacy of thermal vehicles comes from the fact that they are inexpensive to produce, recharge in a few minutes, offer great autonomy, and consume mainly oil, that is to say abundant and distributed energy at low prices almost everywhere on the planet.

However, in view of the risks that the oil resource poses to the climate and to the energy sovereignty of oil-importing countries, the states of many countries discourage motorists from buying cars with a combustion engine by overtaxing them, and encourage said motorists to buy electric vehicles by means of purchase aids.

Despite this state interventionism, the electrification of the automobile is met with resistance from motorists who are reluctant to buy electric cars that, even subsidised, remain more expensive than their thermal counterparts, are more limited in autonomy, and take longer to recharge.

To these obstacles to the development of electric cars are added the often-problematic access to a charging socket at home or at work, an uncertain resale value, high repair and insurance costs, and an ecological and environmental assessment over the entire mixed life cycle.

In addition, the significant pressure exerted by the “all-electric” strategy on mineral resources and on electricity production makes the projections on the effective future penetration of electric cars uncertain.

Taking into account the uncertainties about the future of the electric car, and the growing environmental and energy constraints, improving the energy efficiency of reciprocating internal combustion engines seems essential, due to the large market share of said engines and their high potential for commercial deployment.

In parallel with said improvement, the development of low-carbon or carbon-neutral fuels such as electro-fuels produced from green hydrogen and carbon dioxide directly captured in the atmosphere seems to be the way to go, in addition to the production of a sustainable share of biofuels from biomass.

One of the most effective strategies for increasing the efficiency of spark ignition reciprocating internal combustion engines is to equip them with ignition pre-chambers known per se, generally one per cylinder.

The ignition pre-chambers are designed to emit, via ignition torch emission orifices, high-temperature ignition torches in the main combustion chamber of said engines, in the form of turbulent jets, to ignite a main charge composed of air and fuel contained in said chamber.

The ignition torches release an ignition energy several hundred to several thousand times greater than that delivered by a spark produced between the electrodes of a spark plug, and said torches deploy at high speed in the internal three-dimensional volume of the combustion chamber, generating a vigorous local turbulence in their passage, all causing a rapid and efficient combustion of the main load.

To obtain this result, a pilot charge is introduced into the ignition pre-chamber either in whole or in part through the ignition torch emission orifices, or in whole or in part through an injector which opens into said pre-chamber, or by both, before being ignited by a spark plug known per se, which also opens into said pre-chamber.

To be effective in igniting the main charge and ensuring that it burns quickly, conducive to the efficiency of the heat engine, the pilot charge must be very flammable and reactive, that is to say contain little residual burnt gas from the previous cycle.

This need gives all its interest to the valve ignition pre-chamber which is the subject of the patent belonging to the applicant published on Jul. 19, 2018 under the number WO2018/130772, and to its main improvements, the patents for which, also belong to the applicant, have been published in particular under the No. WO2020053501 and WO2022/079367, said valve separating the internal volume of the pre-chamber from that of the main chamber.

Unlike the pilot charge which must remain pure, the main charge must be diluted with a gas which does not participate in the combustion but which reduces the average temperature of the gases during the combustion of said main charge, reduces the production of nitrogen oxides, and increases the intake pressure of the combustion engine which promotes its efficiency at partial loads.

Thus diluted, the main charge limits heat losses at the internal walls of the main combustion chamber, which is also favorable to the energy efficiency of the combustion engine.

Ideally, the main charge should be diluted with a non-reactive gas that allows the combustion engine to operate at stoichiometry, and which acts as a knock moderator to prevent any detonating combustion of the main charge, destructive for said engine.

Moderating the knocking makes it possible to set a high compression ratio to the combustion engine, which promotes its energy efficiency, and to stall the combustion of the main charge of said engine at the optimum efficiency, these two actions reducing the energy consumption of said engine at the same work produced.

The most obvious way to dilute the main charge with an additional non-reactive gas is to add to the combustion engine an exhaust gas recirculation device called “EGR”, which is the acronym for the English name “ExhaustGas Recirculation”, this to both maintain a stoichiometric main charge, and to moderate the knocking.

A stoichiometric main charge is necessary to post-treat the pollutants that have been produced during the combustion of the main charge by means of a trifunctional catalyst, the latter being notoriously efficient, economical, and widely used in the automotive industry and around the world.

Indeed, engines with an ignition pre-chamber which operate in a lean mixture and which are therefore non-stoichiometric and operate in excess air, require a complex and expensive device for post-treatment of nitrogen oxides by selective catalytic reduction.

The efficiency of these spark ignition engines is comparable to that of equivalent diesel engines, however, since they have the same pollutant post-treatment constraints as diesel engines, producing them is not of interest.

In practice, only engines with an ignition pre-chamber operating at stoichiometry and the main charge of which, is diluted with EGR are of real commercial interest because of their high efficiency on the one hand, and the possibility of post-treating the pollutants by means of a simple trifunctional catalyst on the other hand.

However, such engines require that a fuel mixture composed of air and fuel—and not a fuel alone unlike engines operating in excess of oxygen—be introduced into their ignition pre-chamber, said fuel mixture having preferably been pre-prepared before its introduction into said pre-chamber so as to have the desired fuel richness, and to be perfectly homogeneous.

The prior preparation of said fuel mixture is the objective of the forced recirculation mixer, the patent for which, belonging to the applicant was published on 4 Nov. 2021 under No. WO2021219943, said mixer cooperating with a source of pressurised air such as a compressor known per se.

Once pre-prepared, said fuel mixture is introduced into the ignition pre-chamber by an injector, the tip of which, opens into said pre-chamber.

It is noted that the aforementioned fuel mixture must be introduced into the ignition pre-chamber by a dedicated injector with a high dynamic range and capable of adapting to the various operating conditions of the combustion engine that equips said pre-chamber.

The complexity of controlling such an injector justified patent application No. FR2404917 dated May 14, 2024, entitled “method for injecting an oxidiser-fuel gas mixture”, and belonging to the applicant.

To said complexity is added that of supplying said injector and the air-fuel mixer with which it cooperates with compressed air at the right pressure in all circumstances, that of compressing said air with the highest possible efficiency to avoid degrading that of the internal combustion engine which drives it directly or directly, and that of duly informing the air-fuel mixer about the mass flow rate of said air which passes through it, so that said mixer can mix said air with the required amount of fuel necessary to obtain the desired richness, that is to say to obtain the good mass ratio between said air and said fuel.

It is noted in patent application No. FR2404917 that the air compressor in charge of compressing the air to be supplied to the air-fuel mixer is advantageously driven in rotation by an electric motor.

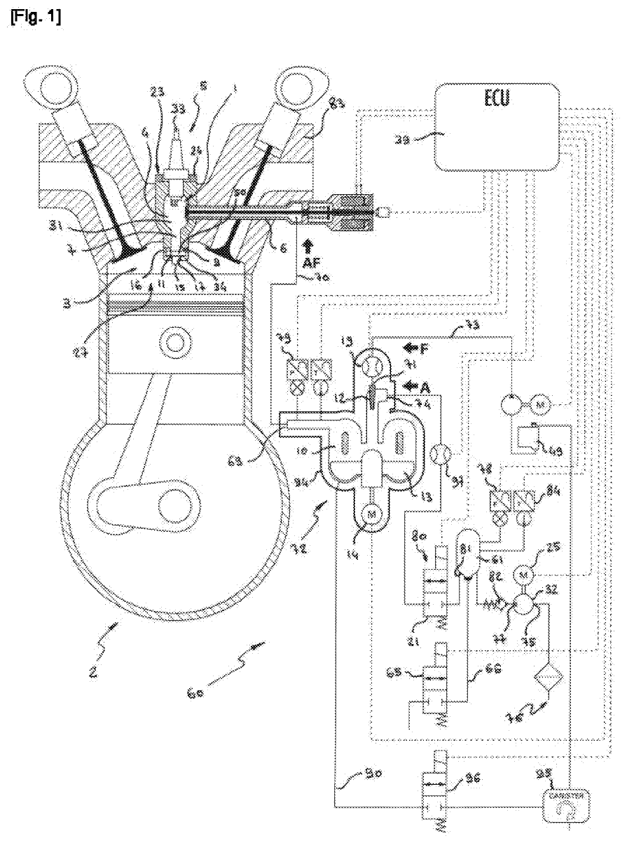

This particular configuration has the advantage of great flexibility compared to that shown schematically in FIG. 1 of patent WO2021219943, in which said compressor is driven by the crankshaft of the internal combustion engine itself.

Said flexibility makes it possible in particular to adapt the rotational speed of the air compressor to large variations in the flow rate of compressed air passing through the air-fuel mixer, said flow rate being not only related to the speed of the combustion engine, but also to the charge of the latter.

However, it is noted that even driven by electrical means, the air compressor can not adapt to the extremely low air flow rates found at idle of the internal combustion engine, said flow rates being of the order of a hundred times lower than those found when said engine operates at maximum power.

Indeed, if the air compressor is for example designed to run at a maximum speed of three thousand revolutions per minute when the internal combustion engine is operating at maximum power, it is not possible to run it only at thirty revolutions per minute when said engine is idling because at this latter speed, the efficiency of said compressor would be practically zero.

One could imagine throttling the intake of said air compressor with a butterfly valve or a ball valve, however, the air pressure at the inlet of the air-fuel mixer must be of the order of thirty to forty bars, which implies providing a multi-stage compression air compressor with inter-stage coolers to give said compressor sufficient efficiency, and to prevent an oil that lubricates said compressor from coking at the outlet valves of each stage.

The problem is that if the inlet of said air compressor is restricted while maintaining an outlet pressure of the order of thirty to forty bars, the compression ratios between the stages are no longer identical, the efficiency of the compressor can only deteriorate, and a limit temperature of the order of one hundred and fifty degrees Celsius at the stage outlet will be exceeded so that the oil vapors will coke at the outlet valves of said compressor to the point of rapidly rendering it inoperative.

In addition, there are inevitable losses of energy by pumping due to the throttling of the intake of said air compressor.

The best solution in this context is to provide for fractional operation of the compressor, which involves storing compressed air and managing the corresponding storage means.

In addition, the difficulty represented by a supply under thirty to forty bars of a very low mass flow rate of air and fuel is in particular the measurement of the mass flow rate of air.

Indeed, the pilot charge formed of air and fuel in due proportion and which is introduced into the ignition pre-chamber is very small, and may represent only one percent of the total charge introduced into the cylinder of the internal combustion engine.

Measuring the resulting extremely low air flow rates is complex with economically acceptable automotive technologies such as wire or hot film flowmeters.

In addition, these technologies are still expensive and unreliable, causing many failures.

It is in particular to solve these problems related to the production of compressed air to supply an air-fuel mixer of any type under advantageous conditions of economy, compactness, energy efficiency, reliability and controllability, and those related to the measurement of the flow rate of compressed air passing through said air-fuel mixer, that the fuel mixture supply system according to the invention results in the possibility:
To reliably operate a compact and energy efficient compressor to the best of its efficiency to supply any air-fuel mixer of any type operating at pressures ranging from a few bars to a few dozen bars;
To measure accurately and at a lower cost the mass flow rate of compressed air passing through the air-fuel mixer so that the latter can produce a mixture of air and fuel in precisely controlled proportions;
To guarantee the absence of any leakage of polluting gas into the environment.

In addition, the fuel mixture supply system according to the invention makes it possible to take full advantage of the invention relating to patent WO2018/130772, and to its main improvements, for which the patents published under No. WO2020053501 and WO2022/079367 belong to the applicant.

The fuel mixture supply system according to the invention also makes it possible to operate under the best conditions the forced recirculation mixer, the patent for which No. WO2021219943 belongs to the applicant, as well as, with regard to the air compressor, patent No. WO2022074321 also belongs to the applicant and relates to a valve plate with free microbeads.

It is understood that the fuel mixture supply system according to the invention can not only be applied to an active ignition pre-chamber with or without a valve, but also to any other application which is similar in concept and in principle and which could benefit from the characteristics and functionalities of said system.

The fuel mixture supply system for supplying a fuel mixture AF to an ignition pre-chamber arranged in a cylinder head of an internal combustion engine, said cylinder head capping a combustion chamber while the ignition pre-chamber comprises, on the one hand, a lamination cavity in which ignition means open, and on the other hand, at least one lamination injector, while a lamination duct connects said cavity to the combustion chamber by means of at least one gas ejection orifice which opens into said chamber, comprises:
At least one air compressor which comprises at least one air inlet port connected directly or indirectly to an air source, said compressor also comprising at least one compressed air outlet port which is directly or indirectly connected to a compressed air reservoir;
At least one air-fuel mixer which has a mixer outlet connected to the lamination injector by a fuel mixture duct in which a fuel mixture AF circulates, said mixer also comprising, on the one hand, at least one fuel inlet connected to a fuel source by a fuel duct in which a fuel F circulates, and on the other hand, at least one mixer compressed air inlet connected to the compressed air reservoir via a reservoir outlet port of said reservoir, compressed air A being able to enter said mixer through said inlet;
At least one reservoir pressure sensor that measures the pressure that prevails in the compressed air reservoir;
At least one controlled pressure regulator placed between the reservoir outlet port and the mixer compressed air inlet;
At least one mixer pressure sensor that measures the pressure that prevails at the mixer compressed air inlet;
At least one computer that coordinates at least the operation of the air compressor and the controlled pressure regulator according to the pressures measured, on the one hand, by the reservoir pressure sensor, and, on the other hand, by the mixer pressure sensor.

The fuel mixture supply system according to the invention comprises a compressor outlet check valve that prevents compressed air A from flowing from the compressed air reservoir to the compressed air outlet port.

The fuel mixture supply system according to the invention comprises a reservoir temperature sensor which transmits to the computer the temperature of a compressed air A contained in the compressed air reservoir.

The fuel mixture supply system according to the invention comprises an air compressor which comprises a rotational speed sensor which transmits to the computer the rotational speed of said compressor.

The fuel mixture supply system according to the invention comprises an air compressor which comprises several compression stages and at least one compressed air intercooler A between each said stage.

The fuel mixture supply system according to the invention comprises a mobile coupling of the air compressor which consists of at least one two-piston body in which an oblong recess is arranged which cooperates with the crankpin of a compressor crankshaft.

The fuel mixture supply system according to the invention comprises a compressor crankshaft which is housed in a compressor casing, at least one side of which receives an intercooler in which, on the one hand, a cooling fluid circulates and, on the other hand, compressed air A to be cooled, said cooler also being directly or indirectly in contact with the lubricating oil contained in the compressor casing.

The fuel mixture supply system according to the invention comprises an air-fuel mixer which is entirely or partially housed in a sealed multifunctional enclosure connected to a pollutant retention filter by a pollutant evacuation duct.

The fuel mixture supply system according to the invention comprises an air-fuel mixer which comprises a mixer decompression valve controlled by the computer and which allows the oxidiser-fuel mixture AF contained in said mixer to escape from said mixer to flow towards the pollutant retention filter passing wholly or partially through the interior of the sealed multifunctional enclosure.

The fuel mixture supply system according to the invention comprises a gas flowmeter which measures the flow rate of compressed air A admitted to the mixer compressed air inlet or the flow rate of an oxidiser-fuel mixture AF expelled at the mixer outlet.

The fuel mixture supply system according to the invention comprises a gas flowmeter which comprises:
At least one flowmeter piston housed with low clearance or in a sealed manner in a flowmeter cylinder in which it can translate so as to define, on the one hand, an upstream flowmeter chamber of variable volume into which the compressed air A or the oxidiser-fuel mixture AF arrives, and, on the other hand, a downstream flowmeter chamber, also of variable volume, from which the compressed air A or the oxidiser-fuel mixture AF leaves;
A piston return spring which tends to move the flowmeter piston closer to the upstream flowmeter chamber and which therefore tends to minimise the volume of said upstream chamber;
A flow passage groove, open or not, arranged in the radial thickness of the flowmeter piston or in that of the flowmeter cylinder, said groove leaving a section for the compressed air A or the oxidiser-fuel mixture AF to pass from the upstream flowmeter chamber to the downstream flowmeter chamber, which is all the larger as the volume of the downstream flowmeter chamber is small;
Measuring means for measuring the position of the flowmeter piston which transmit to the computer the axial position of the flowmeter piston in the flowmeter cylinder.

The fuel mixture supply system according to the invention comprises an upstream flowmeter chamber and/or a downstream flowmeter chamber which comprises a flowmeter temperature sensor, the measured value of which, is transmitted to the computer.

The fuel mixture supply system according to the invention comprises a gas flowmeter which is housed in the compressed air reservoir while the downstream flowmeter chamber receives the reservoir outlet port.

The fuel mixture supply system according to the invention comprises a controlled pressure regulator which consists of a controlled pressure regulator solenoid valve, the opening of which is controlled by the computer.

The fuel mixture supply system according to the invention comprises a lamination duct which opens into the combustion chamber in the form of a non-magnetic pre-chamber tip in which is housed a guide pin valve which, when it rests on a duct closure seat, can close said duct, said valve being oriented by an orientation pin which can slide in an axial guide orifice arranged in said pre-chamber tip, the latter forming, with said valve and when the latter does not close the lamination duct, a torch ignition pre-chamber which connects the lamination cavity to the combustion chamber by means of the gas ejection orifice.

The fuel mixture supply system according to the invention comprises a guide pin valve which is returned to the duct closure seat by a source of closing magnetic field.

The method for implementing the fuel mixture supply system consists, when the air compressor is stopped, in determining the mass flow rate of a compressed air A which is introduced at the compressed air inlet of the mixer on the basis of the drop per unit of time in the pressure and the temperature of a compressed air A contained in the compressed air reservoir, said pressure and said temperature being transmitted to the computer respectively by the reservoir pressure sensor and by the reservoir temperature sensor.

The method for implementing the fuel mixture supply system consists, when the flow rate of compressed air A at the reservoir outlet port is zero, in determining the volumetric efficiency of the air compressor on the basis of the rise per unit time of the pressure and the temperature of a compressed air A contained in the compressed air reservoir according to the rotational speed of the air compressor, said pressure, said temperature, and said rotational speed being transmitted to the computer respectively by the reservoir pressure sensor, by the reservoir temperature sensor, and by the rotational speed sensor.

The method for implementing the fuel mixture supply system consists, when the air compressor is rotating, in determining the mass flow rate of a compressed air A which is introduced into the compressed air inlet of the mixer, on the basis of the volumetric efficiency of the air compressor on the one hand, and on the basis of the variation per unit time of the pressure and the temperature of said air A contained in the compressed air reservoir on the other hand, said pressure and said temperature being transmitted to the computer respectively by the reservoir pressure sensor and by the reservoir temperature sensor.

The description below in reference to the appended drawings given only as non-limiting examples will make it possible to better understand the invention, its features, and the advantages that it is capable of providing:

FIG. 1 is a schematic representation of the fuel mixture supply system according to the invention, and a schematic cross-section of the internal combustion engine and its accessories to which said method relates.

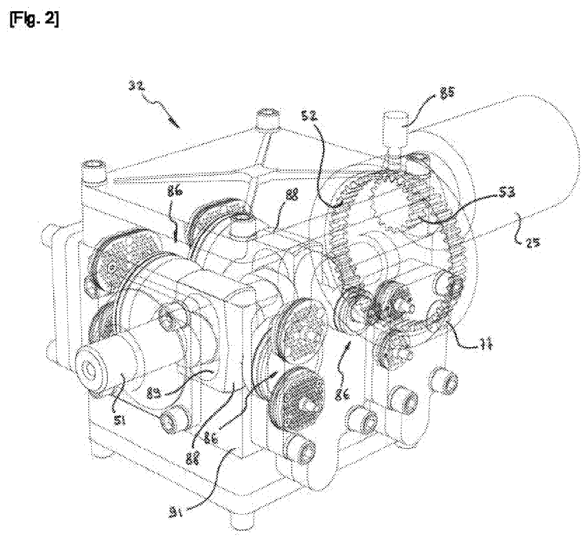

FIG. 2 is a view is a phantom three-dimensional view of a compressor such as may be included in the fuel mixture supply system according to the invention, said compressor comprising three compression stages and a compressed air intercooler A between each said stage, while the mobile coupling of said compressor consists of two bodies with two pistons in which is arranged an oblong recess which cooperates with the crankpin of a compressor crankshaft.

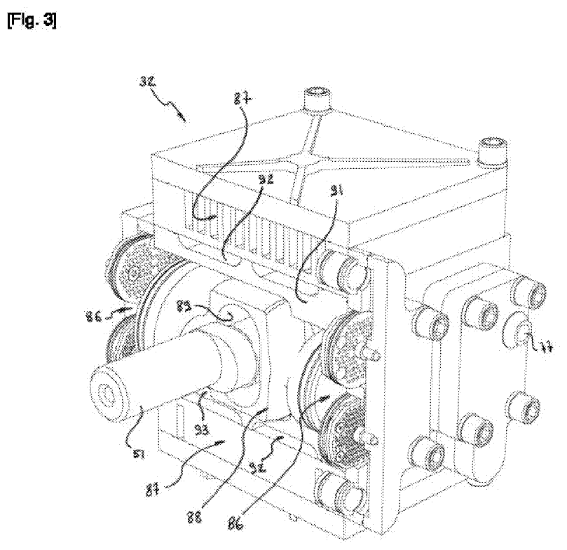

FIG. 3 is a three-dimensional cross-sectional view of the compressor shown in FIG. 2 which shows that, according to the fuel mixture supply system according to the invention, the compressor crankshaft can be housed in a compressor casing, two faces of which receive an intercooler in which circulates, on the one hand, a cooling fluid, and, on the other hand, compressed air to be cooled, said cooler also being in contact with the lubricating oil contained in said casing.

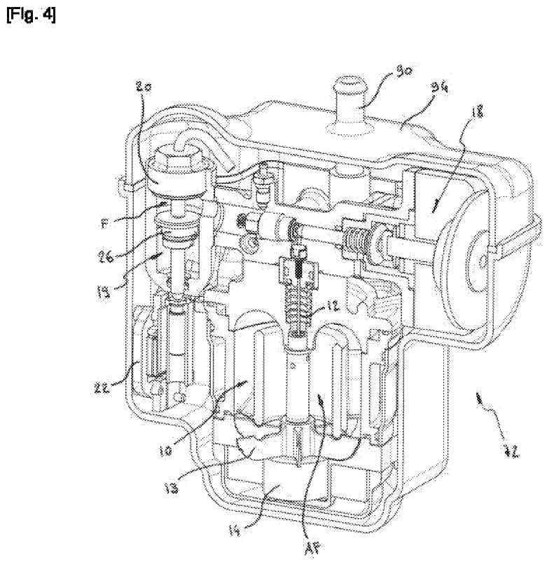

FIG. 4 is a three-dimensional cross-sectional view of an air-fuel mixer based on the same principle as that described in patent No. WO2021219943 but according to a particularly compact configuration, and which, according to the fuel mixture supply system according to the invention, is housed in a sealed multifunctional enclosure connected to a pollutant retention filter (95).

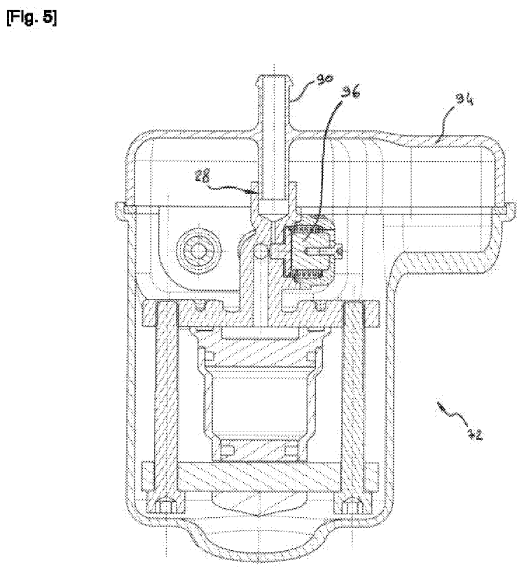

FIG. 5 is a view of the air-fuel mixer shown in FIG. 4 in a section centered on a controlled mixer decompression valve which allows, according to the fuel mixture supply system according to the invention, the oxidiser-fuel mixture AF contained in said air-fuel mixer to escape therefrom to flow towards a pollutant retention filter, this partly passing through the inside of the sealed multifunctional enclosure.

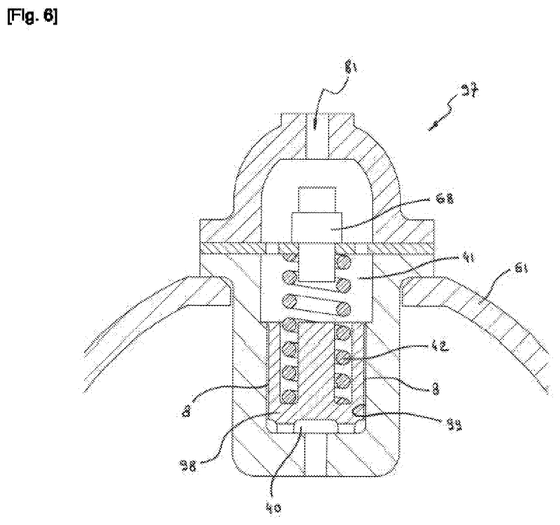

FIG. 6 is a schematic cross-sectional view of a gas flowmeter which measures the flow rate of compressed air admitted to the compressed air inlet of the mixer or the flow rate of an oxidiser-fuel mixture AF expelled at the outlet of the mixer, said flowmeter consisting, according to the fuel mixture supply system according to the invention, of a flowmeter piston housed in a flowmeter cylinder, the flow passage groove and the piston return spring of which, allow a computer to calculate said flow rate from the axial position of the flowmeter piston in the flowmeter cylinder.

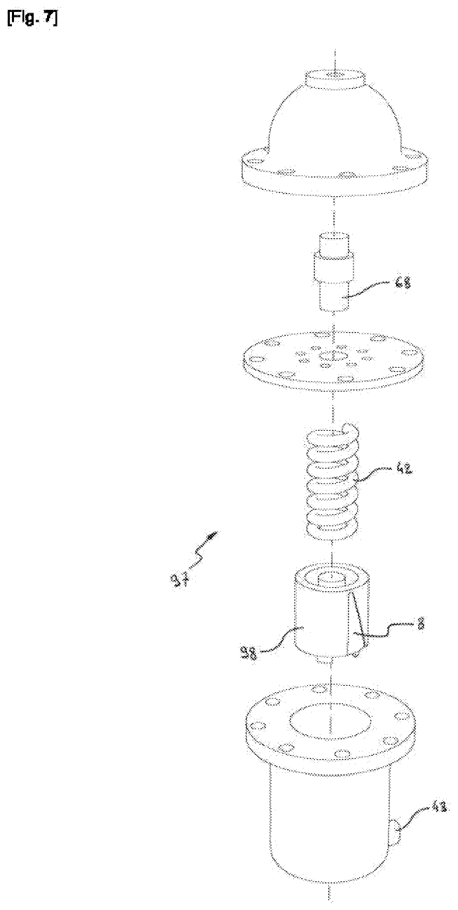

FIG. 7 is an exploded three-dimensional view of the main components of the gas flowmeter shown in FIG. 6.

### DESCRIPTION OF THE INVENTION

FIGS. 1 to 7 show the fuel mixture supply system 60 according to the invention, various details of its components, its variants, and its accessories.

In FIG. 1, it has been shown that the fuel mixture supply system 60 according to the invention is provided for supplying fuel mixture AF to an ignition pre-chamber 1 arranged in a cylinder head 83 of an internal combustion engine 2.

It can be seen in FIG. 1 that said cylinder head 83 covers a combustion chamber 3 while the ignition pre-chamber 1 comprises, on the one hand, a lamination cavity 4 in which ignition means 5 open and, on the other hand, at least one lamination injector 6.

FIG. 1 also shows that a lamination duct 7 connects the lamination cavity 4 to the combustion chamber 3 by means of at least one gas ejection orifice 16 which opens into said chamber 3.

FIGS. 1 to 3 show that the fuel mixture supply system 60 according to the invention comprises at least one air compressor 32 which comprises at least one air inlet port 75 directly or indirectly connected to an air source 76, said compressor 32 also comprising at least one compressed air outlet port 77 which is directly or indirectly connected to a compressed air reservoir 61.

FIGS. 1, 4 and 5 show that the fuel mixture supply system 60 according to the invention comprises at least one air-fuel mixer 72 which has a mixer outlet 69 connected to the lamination injector 6 by a fuel mixture duct 70 in which a fuel mixture AF circulates.

It is noted in FIG. 1 that the air-fuel mixer 72 also comprises, on the one hand, at least one fuel inlet 71 connected to a fuel source 49 by a fuel duct 73 in which a fuel F circulates, and on the other hand, at least one mixer compressed air inlet 74 connected to the compressed air reservoir 61 via a reservoir outlet port 81 of said reservoir 61, compressed air A being able to enter said mixer 72 through said inlet 74.

FIG. 1 also illustrates that the fuel mixture supply system 60 according to the invention comprises at least one reservoir pressure sensor 78 which measures the pressure that prevails in the compressed air reservoir 61.

In addition, said system 60 also comprises at least one controlled regulator 80 placed between the reservoir outlet port 81 and the mixer compressed air inlet 74.

It is also noted in FIG. 1 that the fuel mixture supply system 60 according to the invention also comprises at least one mixer pressure sensor 79 which measures the pressure prevailing at the mixer compressed air inlet 74.

Finally, and as shown in FIG. 1, the fuel mixture supply system 60 according to the invention comprises at least one computer 39 that coordinates at least the operation of the air compressor 32 and the controlled regulator 80 as a function of the pressures measured, on the one hand, by the reservoir pressure sensor 78 and, on the other hand, by the mixer pressure sensor 79.

In FIG. 1, it has been shown that the fuel mixture supply system 60 according to the invention can have a compressor outlet check valve 82 which prevents compressed air A from circulating from the compressed air reservoir 61 to the compressed air outlet port 77, said valve 82 preferably being completely sealed, and consisting for this purpose, for example, of a seat made of flexible elastomer which cooperates with a shutter made of hard material.

As an alternative embodiment of the fuel mixture supply system 60 according to the invention shown in FIG. 1, a reservoir temperature sensor 84 can transmit to the computer 39 the temperature of a compressed air A contained in the compressed air reservoir 61.

The fuel mixture supply system 60 according to the invention may also consist, when the air compressor 32 is stopped, in determining the mass flow rate of a compressed air A which is introduced into the mixer compressed air inlet 74 from the drop per unit time in the pressure and the temperature of a compressed air A contained in the compressed air reservoir 61.

In this case, said pressure and said temperature are transmitted to the computer 39 respectively by the reservoir pressure sensor 78 and by the reservoir temperature sensor 84.

Advantageously and in order to optimise the accuracy of determining said compressed air mass flow rate A which has just been described, the compressed air reservoir 61 can be thermally insulated from its external environment by rock wool, insulating foam, or by any other thermally insulating means known to the person skilled in the art.

As shown in FIG. 2, the air compressor 32 may include a rotational speed sensor 85 that transmits the rotational speed of said compressor 32 to the computer 39.

In this case, the rotational speed sensor 85 can, for example, consist of a simple Hall effect sensor which detects the passage of one or more targets arranged at the periphery of one of the rotating elements of the air compressor 32 such as a compressor crankshaft 51 or an inner compressor ring 52 integral with said crankshaft 51.

The fuel mixture supply system 60 according to the invention may also consist, when the flow rate of compressed air A at the reservoir outlet port 81 is zero, in determining the volumetric efficiency of the air compressor 32 on the basis of the rise per unit time of the pressure and the temperature of a compressed air A contained in the compressed air reservoir 61 according to the rotational speed of the air compressor 32.

In this case, said pressure, said temperature, and said rotational speed are transmitted to the computer 39 respectively by the reservoir pressure sensor 78, by the reservoir temperature sensor 84, and by the rotational speed sensor 85.

Since the computer 39 knows the geometric displacement of the air compressor 32 as well as the pressure and the temperature of the air source 76 via other sensors that a vehicle equipped with the internal combustion engine 2 comprises, it can deduce by calculation the volumetric efficiency of the air compressor 32.

Thus, the fuel mixture supply system 60 according to the invention can consist, when the air compressor 32 is rotating, in determining the mass flow rate of a compressed air A which is introduced into the mixer compressed air inlet 74, on the basis of the volumetric efficiency of the air compressor 32, on the one hand, and on the basis of the variation per unit time of the pressure and the temperature of said air A contained in the compressed air reservoir 61, on the other hand, said pressure and said temperature being transmitted to the computer 39 respectively by the reservoir pressure sensor 78 and by the reservoir temperature sensor 84.

According to a particular variant embodiment of the fuel mixture supply system 60 according to the invention shown in FIGS. 2 and 3, the air compressor 32 may comprise several compression stages 86 and at least one intercooler 87 for compressed air A between each said stage 86.

It can be seen that, by way of another variant also shown in FIGS. 2 and 3, the mobile coupling of the air compressor 32 may advantageously consist of at least one two-piston body 88 in which is arranged an oblong recess 89 which cooperates with the crankpin of a compressor crankshaft 51 according to a configuration commonly known as a “scotch yoke” mechanism.

It should also be noted that the compressor crankshaft 51 can be housed in a compressor casing 91, at least one side of which, receives an intercooler 87 in which circulates, on the one hand, a cooling fluid 92 and, on the other hand, compressed air A to be cooled, said cooler also being directly or indirectly in contact with the lubricating oil 93 contained in the compressor casing 91.

It has been shown in FIGS. 1, 4 and 5 that the air-fuel mixer 72 can be housed in whole or in part in a sealed multifunctional enclosure 94 connected to a pollutant retention filter 95 by a pollutant evacuation duct 90, said pollutant retention filter 95 also being known by the term “canister” and usually used in so-called “EVAP” systems for “Evaporative Emission Control System”, said “canister” collecting any leaks of fuel mixture AF occurring at the various components or assembly interfaces of said mixer 72.

In FIGS. 1 and 5, it is noted that according to a particular configuration of the fuel mixture supply system 60 according to the invention, the air-fuel mixer 72 can comprise a mixer decompression valve 96 controlled by the computer 39, said valve 96 allowing the oxidiser-fuel mixture AF contained in said mixer 72 to escape from said mixer 72 to flow towards the pollutant retention filter 95 by passing wholly or partly through the interior of the sealed multifunctional enclosure 94.

It has been shown in FIG. 1 that a gas flowmeter 97 can measure the flow rate of a compressed air A admitted to the mixer compressed air inlet 74 or that, by way of a variant not shown, said flowmeter 97 can measure the flow rate of an oxidiser-fuel mixture AF expelled at the outlet of the mixer 69.

In this case, it has been shown in FIGS. 6 and 7 that the gas flowmeter 97 can comprise at least one flowmeter piston 98 housed with little clearance or in a sealed manner in a flowmeter cylinder 99 in which it can translate so as to define, on the one hand, an upstream flowmeter chamber 40 of variable volume into which the compressed air A or the oxidiser-fuel mixture AF arrives, and, on the other hand, a downstream flowmeter chamber 41, also of variable volume, from which the compressed air A or the oxidiser-fuel mixture AF leaves.

According to this particular variant, a piston return spring 42 tends to bring the flowmeter piston 98 closer to the upstream flowmeter chamber 40 and therefore tends to minimise the volume of said upstream chamber 40.

Still according to this variant, it is noted in FIGS. 6 and 7 that a flow passage groove 8, open or not, is arranged in the radial thickness of the flowmeter piston 98 or in that of the flowmeter cylinder 99, said groove 8 leaving a section for the compressed air A or the oxidiser fuel mixture AF to pass from the upstream flowmeter chamber 40 to the downstream flowmeter chamber 41, which is all the larger as the volume of the downstream flowmeter chamber 41 is small.

According to this particular embodiment of the gas flowmeter 97, the flowmeter piston position measuring means 68 transmit to the computer 39 the axial position of the flowmeter piston 98 in the flowmeter cylinder 99.

This variant, depending on the fuel mixture supply system 60 according to the invention, can provide for the upstream flowmeter chamber 40 and/or the downstream flowmeter chamber 41 to comprise a flowmeter temperature sensor 43, the measured value of which is transmitted to the computer 39.

As illustrated in FIG. 6, the gas flowmeter 97 that has just been described can be housed in the compressed air reservoir 61 while the downstream flowmeter chamber 41 receives the reservoir outlet port 81.

It has been shown in FIG. 1 that the controlled pressure regulator 80 can be constituted by a controlled pressure regulator solenoid valve 21, the opening of which is controlled by the computer 39.

FIG. 1 also shows that according to a particular embodiment of the fuel mixture supply system 60 according to the invention, the lamination duct 7 can open into the combustion chamber 3 in the form of a non-magnetic pre-chamber tip 34 in which a guide pin valve 50 is housed, which, when it rests on a duct closure seat 11, can close said duct 7.

In this case, said valve 50 is advantageously oriented by an orientation pin 15 which can slide in an axial guide orifice 17 arranged in the non-magnetic pre-chamber tip 34, the latter forming, with said valve 50 and when the latter does not close the lamination duct 7, a torch ignition pre-chamber 9 which connects the lamination cavity 4 to the combustion chamber 3 by means of the gas ejection orifice 16.

By way of improvement shown in FIG. 1, the guide pin valve 50 can be returned to the duct closure seat 11 with which it cooperates by a closing magnetic field source 23.

### OPERATION OF THE INVENTION

The operation of the fuel mixture supply system 60 for an ignition pre-chamber 1 according to the invention is easily understood in view of FIGS. 1 to 7.

In FIG. 1, it has been shown that the fuel mixture supply system 60 according to the invention applies to an internal combustion engine 2 which receives an ignition pre-chamber 1, the latter comprising a lamination cavity 4 into which open a lamination injector 6 and ignition means 5, represented here in the form of a spark plug 33 known per se.

Still in FIG. 1, it is noted that the lamination cavity 4 is connected to the combustion chamber 3 of the internal combustion engine 2 by a lamination duct 7, the latter opening according to this example into said chamber 3 in the form of a non-magnetic pre-chamber tip 34 in which is housed a guide pin valve 50 such as that described in patent WO2022/079367 belonging to the applicant.

However, it is not essential that the ignition pre-chamber 1 comprises a guide pin valve 50 or any valve whatsoever, a valve, whatever its type, not being essential to the operation of the fuel mixture supply system 60 according to the invention.

At each cycle of the internal combustion engine 2, the lamination injector 6 introduces into the lamination cavity 4 a pilot charge 31 consisting of an oxidiser-fuel mixture AF, said charge 31 then being ignited by the spark plug 33.

The result of said ignition of said pilot charge 31 is that burnt or burning gases are ejected from the lamination cavity 4 successively by the lamination duct 7, by the torch ignition pre-chamber 9 that forms the guide pin valve 50 with the pre-chamber tip 34 according to the non-limiting example of embodiment shown in FIG. 1 of the fuel mixture supply system 60 according to the invention, then by gas ejection orifices 16.

This has the effect of igniting a main charge 27 contained in the combustion chamber 3.

The objective of the fuel mixture supply system 60 according to the invention is to allow the various components responsible for forming the oxidiser-fuel mixture AF to operate optimally, and to convey said mixture AF to the lamination injector 6.

Indeed, said AF mixture must be supplied to the lamination injector 6 under a pressure of the order of thirty to forty bars, be composed of air and fuel in precise proportions, be practically entirely in the vapour state without risk of fuel recondensation, and be perfectly homogeneous.

In this, the air-fuel mixer 72 shown in FIG. 1 and in FIGS. 4 and 5 plays an essential role, said mixer as shown in said Figures being a compact and pre-optimised version for mass production of the forced recirculation mixer, the patent for which belonging to the applicant has been published under No. WO2021219943.

It is noted, particularly in FIGS. 4 and 5, that the air-fuel mixer 72 comprises in particular a liquid injection nozzle 12 which injects into a mixing chamber 10 a fuel F previously pressurised by a pulsed fuel pump 18, a mixing turbine 13 driven in rotation by a turbine engine 14 vigorously mixing the air and the fuel in said chamber 10 to form a perfectly homogeneous oxidiser-fuel mixture AF.

To ensure an accurate air-fuel ratio, it is noted that a mixer fuel flowmeter 19 measures the amount of fuel F injected by the liquid injection nozzle 12 so that a computer 39 can adjust the operating frequency of the fuel pulse pump 18 according to the flow rate of compressed air A introduced at the mixer compressed air inlet 74.

The mixer fuel flowmeter 19 consists of a fuel flowmeter piston 26, the displacement of which is measured by a fuel flowmeter piston position sensor 22.

The fuel mass flow rate is calculated from the section of the fuel flowmeter piston 26, the speed of advance of said piston 26, and the temperature of the fuel from which its density results, said temperature being measured by a combined stopper-stop-temperature-sensor 20 that has been shown in FIG. 4.

It can be seen in FIGS. 4 and 5 that the air-fuel mixer 72 is advantageously housed in a sealed multifunctional enclosure 94 connected to a pollutant retention filter 95 by a pollutant evacuation duct 90, said filter 95 also being known as a “canister” and being usually used in so-called “Evaporative Emission Control System” (EVAP) systems.

Said “canister” collects any leaks of fuel mixture AF occurring at the various components or assembly interfaces of the air-fuel mixer 72.

In addition, and as shown in FIG. 5, the air-fuel mixer 72 can comprise a mixer decompression valve 96 controlled by the computer 39 which allows the oxidiser-fuel mixture AF contained in said mixer 72 to escape from said mixer 72 to flow towards the pollutant retention filter 95, passing in whole or in part through the inside of the sealed multifunctional enclosure 94.

Thus, the oxidiser-fuel mixture AF contained in the mixing chamber 10 can be retained and then recycled by the pollutant retention filter 95 when the internal combustion engine 2 cools, so as to gradually decompress said chamber 10 as it cools, and so as to prevent the fuel contained in the form of vapor in the oxidiser-fuel mixture AF from re-condensing under the effect of pressure.

It can be seen in FIG. 5 that an unsealed connection 28 connects the outlet of the mixer decompression valve 96 with a pollutant evacuation duct 90 responsible for conveying the vapors to the pollutant retention filter 95, so that other vapors possibly present in the sealed multifunctional enclosure 94 can also join the pollutant evacuation duct 90 to also be conveyed to the pollutant retention filter 95.

In addition to what has just been described, it is noted that it is necessary, on the one hand, to produce compressed air A at a pressure of, for example, thirty to forty bars, and, on the other hand, that a computer 39 in charge of controlling the air-fuel mixer 72 can accurately determine the mass quantity of air that passes through said mixer 72 so that the latter produces the oxidiser-fuel mixture AF at the required richness.

This requires an air compressor 32 which is preferably a piston and multi-stage air compressor with intercoolers, such a configuration notoriously delivering a high mechanical and thermodynamic efficiency, guaranteeing a high total efficiency of the internal combustion engine 2.

Moreover, the air compressor 32 must be compact to be easily accommodated for example in the compartment of the internal combustion engine 2 or in the rear trunk of an automobile, and inexpensive to produce to meet the economic constraints related to the production of vehicles in mass production.

This is why, according to the fuel mixture supply system 60 according to the invention and as shown in FIGS. 2 and 3, an air compressor 32 with several compression stages 86 can advantageously be provided, with an intercooler 87 of compressed air A between each said stage 86.

To limit the size of said compressor 32, it can be seen in FIGS. 2 and 3 that the mobile coupling of said compressor 32 can advantageously consist of two-piston bodies 88 in which is arranged an oblong recess 89 which cooperates with the crankpin of a compressor crankshaft 51 according to a configuration commonly known as a “scotch yoke” mechanism.

For the sake of maximum compactness, the compressor crankshaft 51 can be housed in a compressor casing 91, at least one side of which receives an intercooler 87 in which circulates, on the one hand, a cooling fluid 92 and, on the other hand, compressed air A to be cooled, said cooling fluid 92 also being indirectly in contact with the lubricating oil 93 contained in the compressor casing 91.

The cooling fluid 92 may be a mixture of water and glycol as ordinarily found in the cooling circuits of automobile internal combustion engines 2, said mixture having to be relatively cold, around forty degrees Celsius.

Said mixture of water and glycol can come from a cold supercharging water circuit similar to those found in automobiles, or come from a dedicated radiator placed, for example, on the front face of a vehicle and the low flow rate of which, ensures a sufficiently low outlet temperature, said radiator sharing the mixture of water and glycol for cooling the internal combustion engine 2 which receives the fuel mixture supply system 60 according to the invention.

It can be seen in FIG. 2 that the air compressor 32 thus formed can be driven in rotation by a compressor electric motor 25 via a compressor ring drive pinion 53 and an inner compressor ring 52 with a reduction ratio of three according to a non-limiting example, which allows to make said motor 25 smaller at the same power by rotating it faster.

However, it is found that the internal combustion engine 2 of an automobile operates over a very wide power range that ranges from idling speed to full power, with a demand for compressed air flow A at the mixer compressed air inlet 74 that varies from simple to a hundredfold or even more.

However, the rotational speed of the air compressor 32 cannot vary by a factor of a hundred and for example go from three thousand revolutions per minute at full power to thirty revolutions per minute at idle.

That is why, as shown in FIG. 1, the fuel mixture supply system 60 according to the invention provides that the compressed air outlet port 77 of the air compressor 32 is connected, preferably via a sealed compressor outlet check valve 82, to a compressed air reservoir 61, the latter being provided with a reservoir pressure sensor 78 which measures the pressure which prevails in said reservoir 61.

This particular configuration makes it possible to store compressed air A so that the air compressor 32 always operates as close as possible to its maximum efficiency when this is possible, with the possibility of limiting the acoustic emissions of said compressor 32 in many cases.

Thus, if the air compressor 32 delivers its maximum best efficiency at a speed of one thousand revolutions per minute, when the internal combustion 2 operates at idle, said air compressor 32 rotates for example a few seconds every three minutes according to the capacity of the compressed air reservoir 61, at one thousand revolutions per minute.

If the compressed air pressure A at the mixer compressed air inlet 74 must, for example, be thirty bars, the air compressor 32 can, also by way of example, start as soon as the pressure measured by the reservoir pressure sensor 78 becomes less than thirty-one bars, while said compressor 32 can stop rotating as soon as the pressure measured by said sensor 78 exceeds thirty-six bars.

The starting and stopping of the compressor 32 as a function of the pressure measured by the reservoir pressure sensor 78 is triggered by a computer 39.

In parallel with this and as shown in FIG. 1, the fuel mixture supply system 60 according to the invention provides for a controlled pressure regulator 80 to be placed between the reservoir outlet port 81 and the mixer compressed air inlet 74, said pressure regulator 80 being instructed according to this example to maintain a pressure of thirty bars at the mixer compressed air inlet 74 whatever the pressure prevailing in the compressed air reservoir 61, and whatever the flow rate of the oxidiser-fuel mixture AF introduced by the lamination injector 6 into the lamination cavity 4.

It is for this reason that, as shown in FIG. 1, the fuel mixture supply system 60 according to the invention provides that a mixer pressure sensor 79 measures the pressure prevailing at the mixer compressed air inlet 74, considering moreover that the pressure is homogeneous between the controlled pressure regulator 80 and the lamination injector 6.

Thus, the computer 39 can open or close a controlled pressure regulator solenoid valve 21 shown in FIG. 1 and which forms the controlled pressure regulator 80, in order to maintain the setpoint pressure of thirty bars at the mixer compressed air inlet 74.

Among the challenges faced by the fuel mixture supply system 60 according to the invention is the measurement of the mass flow rate of compressed air A introduced at the mixer compressed air inlet 74.

It should be noted that this measure is essential for the air-fuel mixer 72 to be able to introduce into the mixing chamber 10 the quantity of fuel F necessary to obtain the desired richness for the oxidiser-fuel mixture AF.

However, it is complex, expensive and hazardous to measure a compressed air mass flow rate A which can fall to minimum values as low as twenty milligrams per second, and maximum values of the order of two grams per second.

That is why the fuel mixture supply system 60 according to the invention provides, according to a particular configuration, for the addition of a reservoir temperature sensor 84 which transmits to the computer 39 the temperature of the compressed air A contained in the compressed air reservoir 61.

Thus, when the air compressor 32 is stopped, the computer 39 can determine the mass flow rate of compressed air A introduced at the mixer compressed air inlet 74 on the basis of the decrease per unit time of the pressure and the temperature of the compressed air A contained in the compressed air reservoir 61, said pressure and said temperature being transmitted to said computer 39 respectively by the reservoir pressure sensor 78 and by the reservoir temperature sensor 84.

It will be noted that the compressed air mass flow rate A resulting from these measurements can be correlated with that resulting from the methods of mass flow rate measurements of oxidiser-fuel mixture AF described in patent application FR2404919 of May 14, 2024, which belongs to the applicant and which is entitled “method of injecting an oxidiser-fuel gas mixture”.

The fuel mixture supply system 60 according to the invention also provides that a rotational speed sensor 85 can transmit to the computer 39 the rotational speed of the air compressor 32, said sensor 85 can, for example, consist of a simple Hall effect sensor that detects the passage of one or more targets arranged on the periphery of one of the rotating elements of the air compressor 32 such as the compressor crankshaft 51 or an inner compressor ring 52 as shown in FIG. 2.

Thus, when the flow rate of compressed air A at the reservoir outlet port 81 is zero, the computer 39 can determine the volumetric efficiency of the air compressor 32 on the basis of the rise per unit time of the pressure and the temperature of the compressed air A contained in the compressed air reservoir 61 according to the rotational speed of the air compressor 32, said pressure, said temperature, and said rotational speed being transmitted to said computer 39 respectively by the reservoir pressure sensor 78, by the reservoir temperature sensor 84, and by the rotational speed sensor 85.

Since the volumetric efficiency of the air compressor 32 is determined, when said compressor 32 is rotating, the mass flow rate of a compressed air A which is introduced into the mixer compressed air inlet 74 can be calculated on the basis of the volumetric efficiency of the air compressor 32, on the one hand, and on the basis of the variation per unit time of the pressure and the temperature of said air A contained in the compressed air reservoir 61, on the other hand, said pressure and said temperature being transmitted to the computer 39 respectively by the reservoir pressure sensor 78 and by the reservoir temperature sensor 84.

These measurements can be supplemented if necessary by a gas flowmeter 97 dedicated to measuring the flow rate of compressed air A admitted to the mixer compressed air inlet 74 or the flow rate of oxidiser-fuel mixture AF expelled at the mixer outlet 69.

This is why the fuel mixture supply system 60 according to the invention provides a gas flowmeter 97 which can consist, as shown in FIGS. 6 and 7, of a flowmeter piston 98 housed with little clearance in a flowmeter cylinder 99 in which it can translate so as to define, on the one hand, an upstream flowmeter chamber 40 of variable volume into which the compressed air A arrives and, on the other hand, a downstream flowmeter chamber 41, also of variable volume, from which the compressed air A leaves.

As can be seen in FIGS. 6 and 7, a piston return spring 42 tends to bring the flowmeter piston 98 closer to the upstream flowmeter chamber 40 and therefore, tends to minimise the volume of said upstream chamber 40.

It will be noted, particularly visible in FIG. 7, that a non-opening flow passage groove 8 is arranged in the radial thickness of the flowmeter piston 98, said groove 8 leaving a certain section for the passage of compressed air A to flow from the upstream flowmeter chamber 40 to the downstream flowmeter chamber 41, said section being all the larger as the volume of the downstream flowmeter chamber 41 is small.

FIGS. 6 and 7 also show that flowmeter piston position measuring means 68 transmit to the computer 39 the axial position of the flowmeter piston 98 relative to that of the flowmeter cylinder 99.

In FIG. 6, it has been shown that advantageously the gas flowmeter 97 which has just been described can be housed in the compressed air reservoir 61 and that in this case, the downstream flowmeter chamber 41 receives the reservoir outlet port 81.

As can be seen in FIG. 6, the pressure difference between that prevailing in the upstream flowmeter chamber 40 and that prevailing in the downstream flowmeter chamber 41 applies to the entire section of the flowmeter piston 98 minus the section of the flow passage groove 8.

The force that the piston return spring 42 produces on the flowmeter piston 98 at any point of its travel is known, taking into account the stiffness of said spring 942.

It is also known that the flow passage groove 8 leaves a section for the compressed air A to pass from the upstream flowmeter chamber 40 to the downstream flowmeter chamber 41, said section being greater the smaller the volume of the downstream flowmeter chamber 41.

Thus, for a given compressed air flow rate A, a balance is established between, on the one hand, the force that the piston return spring 42 produces on the flowmeter piston 98 and which tends to bring the latter closer to the upstream flowmeter chamber 40, and the opposing force that produces on said piston 98 the pressure difference between that prevailing in the upstream flowmeter chamber 40 and that prevailing in the downstream flowmeter chamber 41, said force tending to move said piston 98 away from the upstream flowmeter chamber 40.

Since the passage section left by the flow passage groove 8 determines the pressure difference between the upstream flowmeter chamber 40 and the downstream flowmeter chamber 41, said section is automatically adapted by the axial position of the flowmeter piston 98 in the flowmeter cylinder 99 which is transmitted to the computer 39 by the flowmeter piston position measuring means 68, said computer 39 thus being able to calculate the flow rate of compressed air A which passes through the gas flowmeter 97.

It will be noted that the gas flowmeter 97 which has just been described as provided by the fuel mixture supply system 60 according to the invention can be calibrated at the end of manufacture to establish the effective relationship between the compressed air flow rate A and the axial position of the flowmeter piston 98 in the flowmeter cylinder 99.

It should be noted that the upstream flowmeter chamber 40 and/or the downstream flowmeter chamber 41 may comprise a flowmeter temperature sensor 43 the measured value of which, is transmitted to the computer 39.

This temperature measurement combined with the pressure measurement returned to the computer 39 by the mixer pressure sensor 79 makes it possible to calculate the density of the compressed air A that passes through the gas flowmeter 97, and to correct the mass flow measurement accordingly because the relationship between the compressed air flow rate A and the axial position of the flowmeter piston 98 in the flowmeter cylinder 99 varies with the density of said air A and with its viscosity which depends on its temperature.

It will also have been noted in FIG. 1 the condensate valve 65 which can advantageously be connected to a low point of the compressed air reservoir 61 to extract the condensation water therefrom.

The condensate valve 65 can be connected to said reservoir 61 by a condensate capillary duct 66 so that periodically, said valve 65 can be opened by the computer 39 which will note a slight decrease in the pressure prevailing in the compressed air reservoir 61 when only water passes into the condensate capillary duct 66, then a rapid drop in said pressure when compressed air A passes into said duct 66.

This second case is interpreted by the computer 39 as an absence of condensation water in the compressed air reservoir 61 which calls for an immediate closure of the condensate valve 65.

An alternative may be for the reservoir outlet port 81 to be directly positioned at the lowest point of the compressed air reservoir 61 so that any water condensates are directed to the air-fuel mixer 72 which potentially does not affect its operation.

It will be noted that the example of implementation of the fuel mixture supply system 60 according to the invention which has just been described is non-limiting.

Indeed, said system 60 according to the invention can be applied to other fields than just internal combustion engines. Said system 60 can, for example, be applied to gas nailers, to firearms, or to any apparatus requiring the ignition of a main load by means of a pilot load with the best effectiveness as possible.

The possibilities of the fuel mixture supply system 60 according to the invention are not limited to the applications which have just been described and it must moreover be understood that the above description has been given by way of example only and does not in no way limit the field of the said invention which is not exceeded by replacing the details of implementation described by any other equivalent.

1. A fuel mixture supply system (60) for supplying a fuel mixture AF to an ignition pre-chamber (1) arranged in a cylinder head (83) of an internal combustion engine (2), said cylinder head (83) capping a combustion chamber (3), while the ignition pre-chamber (1) comprises, on the one hand, a lamination cavity (4) into which ignition means (5) open, and, on the other hand, at least one lamination injector (6), while a lamination duct (7) connects said cavity (4) to the combustion chamber (3) by means of at least one gas ejection orifice (16) which opens into said chamber (3), characterised in that it comprises:
At least one air compressor (32) which comprises at least one air inlet port (75) connected directly or indirectly to an air source (76), said compressor (32) also comprising at least one compressed air outlet port (77) which is directly or indirectly connected to a compressed air reservoir (61);
At least one air-fuel mixer (72) which has a mixer outlet (69) connected to the lamination injector (6) by a fuel mixture duct (70) in which a fuel mixture AF circulates, said mixer (72) also comprising, on the one hand, at least one fuel inlet (71) connected to a fuel source (49) by a fuel duct (73) in which a fuel F circulates, and, on the other hand, at least one mixer compressed air inlet (74) connected to the compressed air reservoir (61) by means of a reservoir outlet port (81) which said reservoir (61) has, compressed air A being able to enter said mixer (72) via said inlet (74);
At least one reservoir pressure sensor (78) that measures the pressure that prevails in the compressed air reservoir (61);
At least one controlled pressure regulator (80) placed between the reservoir outlet port (81) and the mixer compressed air inlet (74);
At least one mixer pressure sensor (79) that measures the pressure at the mixer compressed air inlet (74);
At least one computer (39) that coordinates at least the operation of the air compressor (32) and the controlled pressure regulator (80) according to the pressures measured, on the one hand, by the reservoir pressure sensor (78), and, on the other hand, by the mixer pressure sensor (79).

2. The fuel mixture supply system (60) according to claim 1, characterised in that a compressor outlet check valve (82) prevents compressed air A from flowing from the compressed air reservoir (61) to the compressed air outlet port (77).

3. The fuel mixture supply system (60) according to claim 1, characterised in that a reservoir temperature sensor (84) transmits to the computer (39) the temperature of a compressed air A contained in the compressed air reservoir (61).

4. The fuel mixture supply system (60) according to claim 1, characterised in that the air compressor (32) comprises a rotational speed sensor (85) which transmits the rotational speed of said compressor (32) to the computer (39).

5. The fuel mixture supply system (60) according to claim 1, characterised in that the air compressor (32) comprises several compression stages (86) and at least one intercooler (87) for compressed air A between each said stage (86).

6. The fuel mixture supply system (60) according to claim 5, characterised in that the mobile coupling of the air compressor (32) consists of at least one two-piston body (88) in which an oblong recess (89) is arranged which cooperates with the crankpin of a compressor crankshaft (51).

7. The fuel mixture supply system (60) according to claim 5, characterised in that the compressor crankshaft (51) is housed in a compressor casing (91), at least one side of which receives an intercooler (87) in which circulates, on the one hand, a cooling fluid (92) and, on the other hand, compressed air A to be cooled, said cooler also being directly or indirectly in contact with lubricating oil (93) contained in the compressor casing (91).

8. The fuel mixture supply system (60) according to claim 1, characterised in that the air-fuel mixer (72) is entirely or partly housed in a sealed multifunctional enclosure (94) connected to a pollutant retention filter (95) by a pollutant evacuation duct (90).

9. The fuel mixture supply system (60) according to claim 8, characterised in that the air-fuel mixer (72) comprises a mixer decompression valve (96) controlled by the computer (39) and which allows the oxidiser-fuel mixture AF contained in said mixer (72) to escape from said mixer (72) to flow towards the pollutant retention filter (95) passing wholly or partly through the interior of the sealed multifunctional enclosure (94).

10. The fuel mixture supply system (60) according to claim 1, characterised in that a gas flowmeter (97) measures the flow rate of compressed air A admitted to the mixer compressed air inlet (74) or the flow rate of an oxidiser-fuel mixture AF expelled at the mixer outlet (69).

11. The fuel mixture supply system (60) according to claim 10, characterised in that the gas flowmeter (97) comprises:
At least one flowmeter piston (98) housed with low clearance or in a sealed manner in a flowmeter cylinder (99) in which it can translate so as to define, on the one hand, an upstream flowmeter chamber (40) of variable volume into which the compressed air A or the oxidiser-fuel mixture AF arrives, and, on the other hand, a downstream flowmeter chamber (41), also of variable volume, from which the compressed air A or the oxidiser-fuel mixture AF leaves;
A piston return spring (42) which tends to bring the flowmeter piston (98) closer to the upstream flowmeter chamber (40) and which therefore tends to minimise the volume of said upstream chamber (40);
A flow passage groove (8), open or not, arranged in the radial thickness of the flowmeter piston (98) or in that of the flowmeter cylinder (99), said groove (8) leaving a section for the compressed air A or the oxidiser-fuel mixture AF to pass from the upstream flowmeter chamber (40) to the downstream flowmeter chamber (41), which is all the larger as the volume of the downstream flowmeter chamber (41) is small;
Flowmeter piston position measuring means (68) which transmit to the computer (39) the axial position of the flowmeter piston (98) in the flowmeter cylinder (99).

12. The fuel mixture supply system (60) according to claim 11, characterised in that the upstream flowmeter chamber (40) and/or the downstream flowmeter chamber (41) comprises a flowmeter temperature sensor (43), the measured value of which, is transmitted to the computer (39).

13. The fuel mixture supply system (60) according to claim 11, characterised in that the gas flowmeter (97) is housed in the compressed air reservoir (61) while the downstream flowmeter chamber (41) receives the reservoir outlet port (81).

14. The fuel mixture supply system (60) according to claim 1, characterised in that the controlled pressure regulator (80) consists of a controlled pressure regulator solenoid valve (21), the opening of which is controlled by the computer (39).

15. The fuel mixture supply system (60) according to claim 1, characterised in that the lamination duct (7) opens into the combustion chamber (3) in the form of a non-magnetic pre-chamber tip (34) in which is housed a guide pin valve (50) which, when it rests on a duct closure seat (11), can close said duct (7), said valve (50) being oriented by an orientation pin (15) which can slide in an axial guide orifice (17) arranged in said pre-chamber tip (34), the latter forming, with said valve (50) and when the latter does not close the lamination duct (7), a torch ignition pre-chamber (9) which connects the lamination cavity (4) to the combustion chamber (3) by means of the gas ejection orifice (16).

16. The fuel mixture supply system (60) according to claim 15, characterised in that the guide pin valve (50) is returned to the duct closure seat (11) by a closing magnetic field source (23).

17. A method for implementing the fuel mixture supply system (60) according to claim 1, characterised in that it consists, when the air compressor (32) is stopped, in determining the mass flow rate of a compressed air A which is introduced at the mixer compressed air inlet (74) on the basis of the decrease per unit time of the pressure and the temperature of a compressed air A contained in the compressed air reservoir (61), said pressure and said temperature being transmitted to the computer (39) respectively by the reservoir pressure sensor (78) and by the reservoir temperature sensor (84).

18. The method for implementing the fuel mixture supply system (60) according to claim 1, characterised in that it consists, when the compressed air flow rate A at the reservoir outlet port (81) is zero, in determining the volumetric efficiency of the air compressor (32) on the basis of the rise per unit time of the pressure and the temperature of a compressed air A contained in the compressed air reservoir (61) according to the rotational speed of the air compressor (32), said pressure, said temperature, and said rotational speed being transmitted to the computer (39) respectively by the reservoir pressure sensor (78), by the reservoir temperature sensor (84), and by the rotational speed sensor (85).

19. The method for implementing the fuel mixture supply system (60) according to claim 18, characterised in that it consists, when the air compressor (32) is rotating, in determining the mass flow rate of a compressed air A which is introduced into the mixer compressed air inlet (74), on the basis of the volumetric efficiency of the air compressor (32), on the one hand, and on the basis of the variation per unit of time of the pressure and the temperature of said air A contained in the compressed air reservoir (61), on the other hand, said pressure and said temperature being transmitted to the computer (39) respectively by the reservoir pressure sensor (78) and by the reservoir temperature sensor (84).
